(19) United States
(12) Patent Application Publication
(10) Pub. No.: US 2018/0303062 A1
(43) Pub. Date: Oct. 25, 2018

(54) ROBOTIC PET ACCOMPANIMENT SYSTEM AND METHOD

(71) Applicant: KOLONY ROBOTIQUE INC., Chicoutimi (CA)

(72) Inventors: Mikhaël SIMARD, St-Honoré de Chicoutimi (CA); Pascal TREMBLAY, Chicoutimi (CA)

(21) Appl. No.: 15/959,682

(22) Filed: Apr. 23, 2018

Related U.S. Application Data
(60) Provisional application No. 62/488,090, filed on Apr. 21, 2017.

(30) Foreign Application Priority Data
May 9, 2017 (CA) 2966401

(51) Int. Cl. A01K 5/02; B25J 9/00; A01K 15/02; A01K 5/01; B25J 9/16; G05D 1/02

(52) U.S. Cl. CPC A01K 5/0291; B25J 9/0003; G05D 1/0246; A01K 5/0114; B25J 9/1697; A01K 15/021

(57) ABSTRACT

A robotic pet accompaniment system includes a housing defining a substantially closed chamber having a food dispensing opening, a displacement subsystem substantially housed within the housing and a food dispenser located within the substantially closed chamber. The displacement subsystem is controlled to cause displacement of the robotic pet accompaniment system over an underlying surface. The food dispenser is controlled to intermittently dispense food onto the underlying surface. Sensed data may be received from a plurality of distance-enabled sensors and a direction of displacement corresponding to a longest unobstructed path may be chosen and the robotic pet accompaniment system is controlled to be displaced in this direction. The displacement of the robotic pet accompaniment system and the intermittent dispensing of food can stimulate a household pet.

### RELATED PATENT APPLICATION

The present application claims priority from U.S. provisional patent application No. 62/488,090, filed Apr. 21, 2017, and Canadian patent application no. 2.966.401, filed on May 9, 2017, and entitled “ROBOTIC PET ACCOMPANIMENT SYSTEM AND METHOD”, the disclosures of which are hereby incorporated by reference in their entireties.

### TECHNICAL FIELD

The present disclosure generally relates to a robotic pet accompaniment system, and more particularly to an autonomously displaceable accompaniment system operable to automatically dispense pet food.

### BACKGROUND

A large number of households have animal pets. It is estimated that there are approximately 80 million pet dogs in North America alone. Similarly, there are approximately 80 million pet dogs in Europe.

Many pet dogs are left alone at home while their masters are out of the house, such as being at work. It has been observed that some dogs develop behavioural problems due to extended periods of time of being alone at home.

### SUMMARY

According to one aspect, there is provided a robotic pet accompaniment system that includes a housing defining a substantially closed chamber having a food dispensing opening, a displacement subsystem substantially housed within the housing and configured for displacing the housing over an underlying surface, and a food dispenser located within the substantially closed chamber and being displaced with displacement of the housing and configured for selectively dispensing pet food through the food dispensing opening onto the underlying surface.

According to one example embodiment, the food dispenser comprises a hopper for storing pet food to be dispensed and the housing comprises a refill opening aligned with the hopper and a lid configurable in a closed configuration to prevent access to the food dispenser by being superposed to the refill opening, whereby pet food is receivable within the hopper through the refill opening when the lid is in an open configuration.

According to one example embodiment, the housing comprises a chassis and a domed cover defining together the substantially closed chamber, the displacement subsystem being supported by the chassis and the food dispensing opening is formed in the chassis and the domed cover comprises the lid and the refill opening.

According to one example embodiment, the robotic pet accompaniment system further includes a plurality of spatial sensors for detecting the presence of objects in an environment surrounding the housing.

According to one example embodiment, the spatial sensors comprise a plurality of distance-enabled sensors and a plurality of presence sensors.

According to one example embodiment, a first distance-enabled sensor is configured for detecting obstacles in a direction to the front of the housing, a second distance-enabled sensor is configured for detecting obstacles in a direction to a left side of the housing and a third distance-enabled sensor is configured for detecting obstacles in a direction to the right side of the housing.

According to one example embodiment, the pet robotic pet accompaniment system further includes a controller operatively connected to the displacement subsystem. The controller is configured for receiving sensed data from the plurality of distance-enabled sensors of the spatial sensors, the sensed data indicating presence and distance of obstacles in the environment surrounding the housing, determining a direction of displacement based on the received sensed data, and controlling the displacement subsystem to cause displacement of the housing in the determined direction of displacement.

According to one example embodiment, a direction of the longest unobstructed path is determined as the direction of displacement.

According to one example embodiment, the controller is configured for controlling the food dispenser to dispense an amount of food onto the underlying surface at a given location and controlling the displacement subsystem to displace the housing away from the given location immediately after dispensing the amount of food.

According to one example embodiment, the controller is configured for controlling the robotic pet accompaniment system to emit at least one interactive signal at substantially the same time as each dispensing of food onto underlying surface.

According to one example embodiment, the interactive signal is a predefined sequence of movements of the robotic pet accompaniment system caused by operation of the displacement subsystem.

According to one example embodiment, the pet robotic accompaniment further an audio subsystem operable to emit an audio signal and the controller is operatively connected to the audio subsystem. The interactive signal is an audio signal emitted by the audio subsystem.

According to one example embodiment, the interactive signal is emitted prior to the dispensing of an amount of food.

According to one example embodiment, the interactive signal is emitted during a dispensing of an amount of food.

According to one example embodiment, the interactive signal is emitted after the dispensing of an amount of food.

According to one example embodiment, the robotic pet accompaniment system includes a tilt sensor operable to monitor a tilt angle of the housing and a controller operatively connected to the displacement subsystem and the tilt sensor, the controller is configured for receiving a tilt angle measured by the tilt sensor; and controlling the displacement subsystem to stop the displacement upon detecting the tilt angle exceeding a predetermined tilt angle threshold.

According to one example embodiment, the controller is also configured to control the audio subsystem to stop operating upon the detecting the tilt angle exceeding the predetermined tilt angle threshold.

According to one example embodiment, the robotic pet accompaniment system includes a communication module and the controller is configured to receive, via the communication module, a user-inputted food dispensing amount and a user-inputted food dispensing time interval, and to control the food dispenser to dispense the user-inputted amount of food over the food dispensing time interval.

According to one example embodiment, the controller is configured to dispense the user-inputted amount of food in equal portions of the amount at regularly spaced time points over the dispensing time interval.

According to another aspect, there is provided a method for controlling a robotic pet accompaniment system having a displacement subsystem operable to displace the robotic pet accompaniment system and a food dispenser for selectively dispensing food. The method includes controlling the displacement subsystem to cause displacement of the robotic pet accompaniment system over an underlying surface; and controlling the food dispenser to intermittently dispense food onto the underlying surface.

According to yet another aspect, there is provided a method for controlling a robotic pet accompaniment system having a displacement subsystem operable to displace the robotic pet accompaniment system, a food dispenser for selectively dispensing food, and a plurality of distance-enabled spatial sensors. The method includes controlling the displacement subsystem to cause displacement of the robotic pet accompaniment system over an underlying surface by receiving sensed data from the plurality of distance-enabled sensors of the spatial sensors, the sensed data indicating presence and distance of obstacles in the environment surrounding the housing and determining a direction of displacement based on the received sensed data and wherein the direction of displacement corresponds to a longest unobstructed path, and wherein the displacement subsystem is controlled to cause displacement in the determined direction of displacement, and controlling the food dispenser to intermittently dispense food.

According one example embodiment, the robotic pet accompaniment system further comprises a plurality of distance-enabled spatial sensors and the method includes receiving sensed data from the plurality of distance-enabled sensors of the spatial sensors, the sensed data indicating presence and distance of obstacles in the environment surrounding the housing and determining a direction of displacement based on the received sensed data. The displacement subsystem is controlled to cause displacement in the determined direction of displacement.

According to an example embodiment of the method, a direction of the longest unobstructed path is determined as the direction of displacement.

According to an example embodiment, the method further includes emitting at least one interactive signal at substantially the same time as each dispensing of food onto the underlying surface.

According to one example embodiment, an audio signal and the controller is operatively connected to the audio subsystem. The interactive signal is an audio signal emitted by the audio subsystem.

According to one example embodiment, the interactive signal is emitted prior to the dispensing of an amount of food.

According to one example embodiment, the interactive signal is emitted during a dispensing of an amount of food.

According to one example embodiment, the interactive signal is emitted after the dispensing of an amount of food.

According to one example embodiment, the method includes after dispensing an amount of food onto the underlying surface at a given location, immediately displacing the robotic pet accompaniment system away from the given location.

According to one example embodiment, the method further includes monitoring a tilt angle of the robotic pet accompaniment system and controlling the displacement subsystem to stop operation of the displacement subsystem upon detecting the tilt angle exceeding a predetermined tilt angle threshold.

According to one example embodiment, the method further includes receiving a user-inputted food dispensing amount and a user-inputted food dispensing time interval and controlling the food dispenser to dispense the user inputted amount of food over the food dispensing time interval.

According to one example embodiment, the user-inputted amount of food is dispensed in equal portions of the amount at regularly spaced time points over the dispensing time interval.

According to one example embodiment, the food is dispensed on the underlying surface.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a schematic diagram of the operational components of a robotic pet accompaniment system according to one example embodiment;

FIG. 2A illustrates a top plan view of an assembled robotic pet accompaniment system according to an example embodiment;

FIG. 2B illustrates a perspective view of an assembled robotic pet accompaniment system according to the example embodiment;

FIG. 2C illustrates right elevation view of an assembled robotic pet accompaniment system according to the example embodiment;

FIG. 2D illustrates a front elevation view of an assembled robotic pet accompaniment system according to the example embodiment;

FIG. 2E illustrates a left elevation view of an assembled robotic pet accompaniment system according to the example embodiment;

FIG. 2F illustrates a bottom plan view of an assembled robotic pet accompaniment system according to the example embodiment;

FIG. 3 illustrates a transparent elevation view of the assembled robotic pet accompaniment system according to the example embodiment;

FIG. 4A illustrates a side elevation view of the robotic pet accompaniment system according to the example embodiment having an upper cover removed;

FIG. 4B illustrates a perspective view of the robotic pet accompaniment system according to the example embodiment having an upper cover removed;

FIG. 4C illustrates a top plan view of the robotic pet accompaniment system according to the example embodiment having an upper cover removed;

FIG. 5A illustrates a top plan view of the assembled robotic pet accompaniment system according to the example embodiment with its refill lid in an open position;

FIG. 5B illustrates a perspective view of the assembled robotic pet accompaniment system according to the example embodiment with its refill lid in an open position;

FIG. 5C illustrates a right elevation view of the assembled robotic pet accompaniment system according to the example embodiment with its refill lid in an open position;

FIG. 5D illustrates a front elevation view of the assembled robotic pet accompaniment system according to the example embodiment with its refill lid in an open position;

FIG. 5E illustrates a left elevation view of the assembled robotic pet accompaniment system according to the example embodiment with its refill lid in an open position;

FIG. 6A illustrates a cross-sectional view of FIG. 4B of a pet food dispenser according to one example embodiment;

FIG. 6B illustrates a first partial cut-away perspective view of the pet food dispenser according to the example embodiment;

FIG. 6C illustrates a second partial cut-away perspective view of the pet food dispenser according to the example embodiment;

FIG. 7 illustrates a flowchart showing the operational steps of a method according to one example embodiment for operating the robotic pet accompaniment system;

FIG. 8 illustrates a flowchart showing the operational steps of a method according to one example embodiment for displacing the robotic pet accompaniment system.

FIG. 9 illustrates a combined pet accompaniment system according to an example embodiment; and

FIG. 10 illustrates a schematic diagram showing an operating environment of the combined pet accompaniment system according to an example embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

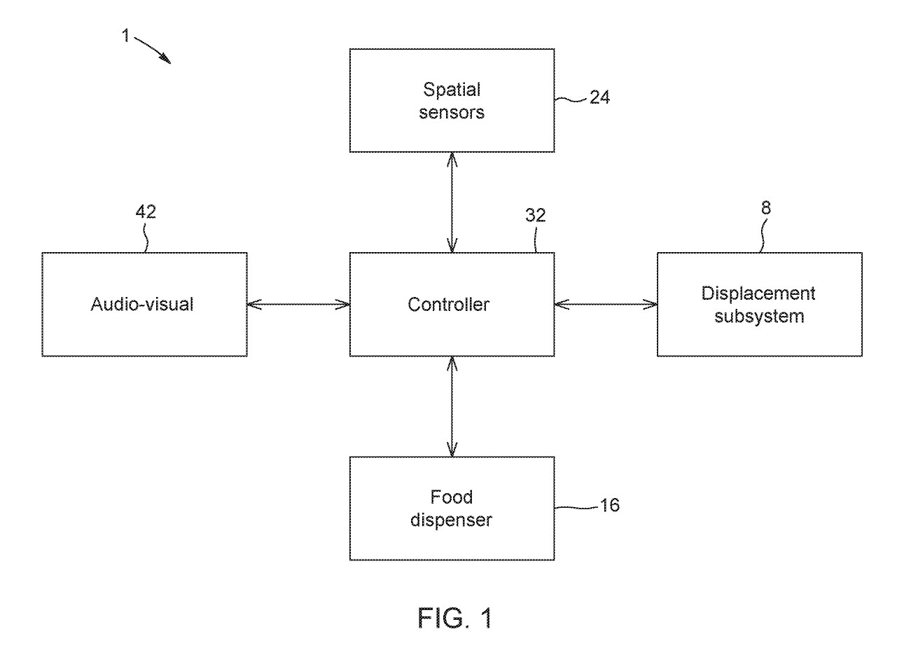

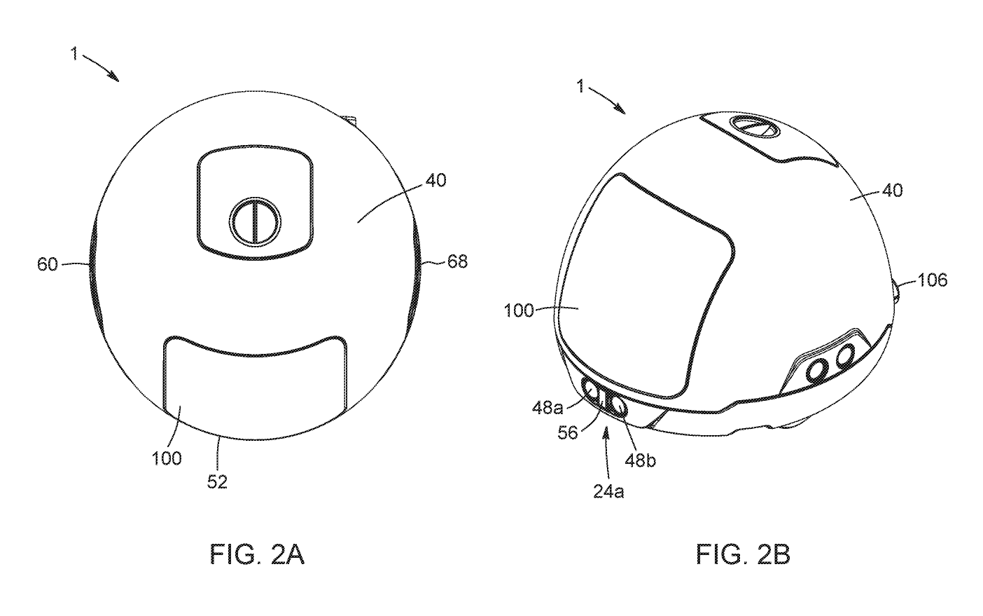

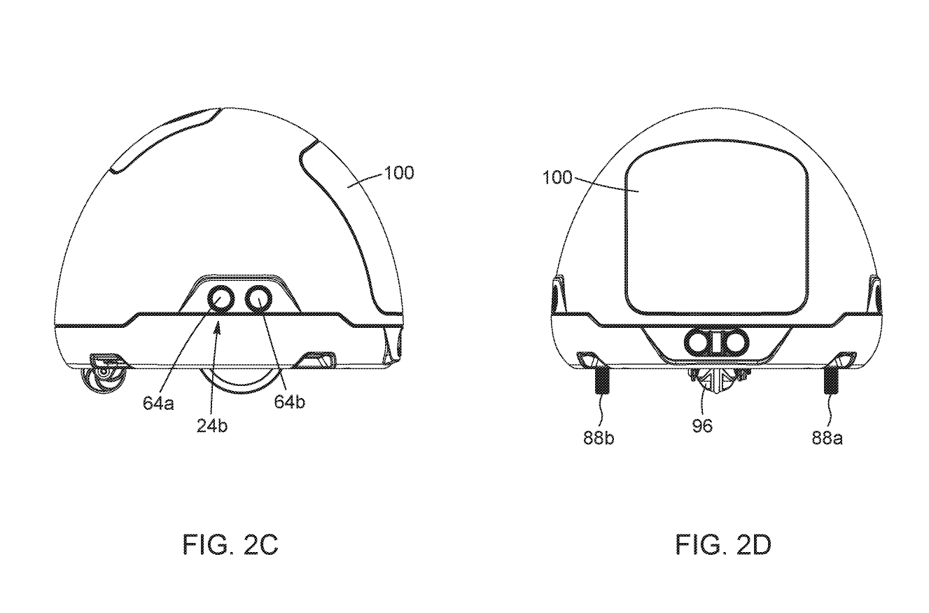

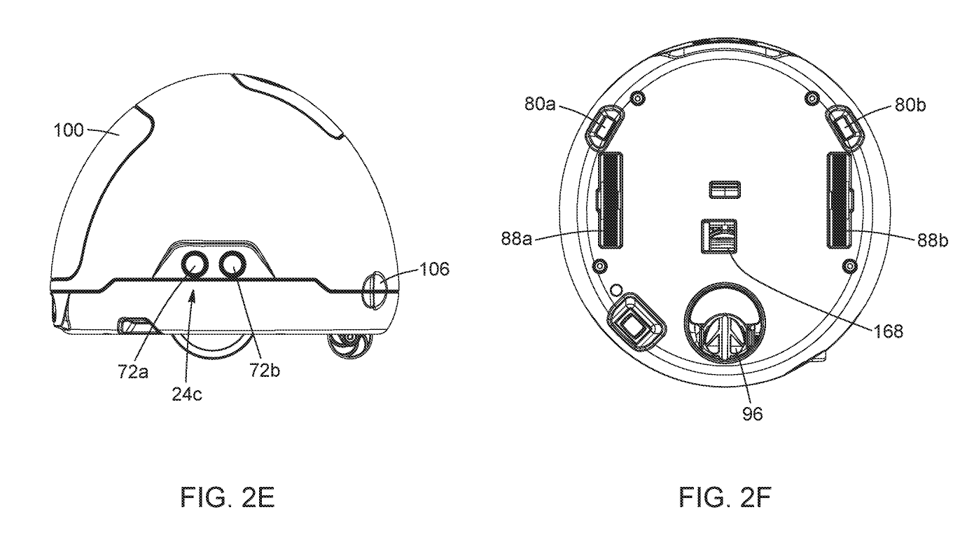

FIG. 1 illustrates a schematic diagram of the operational components of a robotic pet accompaniment system 1 according to one example embodiment. The robotic pet accompaniment system 1 includes a displacement subsystem 8, a food dispenser 16, a plurality of spatial sensors 24 and a controller 32. As described elsewhere herein, the operational components of the robotic pet accompaniment system 1 are housed within a housing 40 (FIGS. 2A and 2B).

The displacement subsystem 8 is configured to be operated to displace the robotic pet accompaniment system 1 over an underlying surface, such as the floor of a home. The displacement subsystem 8 includes a powertrain that generates power and delivers the power to the underlying surface to cause displacement of the robotic pet accompaniment system 1. The displacement subsystem 8 also includes a steering subsystem for changing direction of the displacement of the robotic pet accompaniment system 1. According to some embodiments, the displacement subsystem 8 can be similar to displacement systems used in autonomous home vacuum cleaners known in the art.

The food dispenser is configured to selectively dispense pet food to a space outside of the robotic pet accompaniment system 1. The food dispenser may be housed within the housing 40. The food dispenser subsystem 16 includes a food storage unit for holding the food to be dispensed and a delivery unit for selectively dispensing the food.

It will be understood that as the robotic pet accompaniment system 1 is displaced over the underlying surface from operation of the displacement subsystem 8, the food dispenser subsystem 16 is also displaced. Accordingly, the food is dispensed outside of the robotic pet accompaniment system 1 at the current location of the system. Selectively dispensing the pet food over time and displacing the robotic pet accompaniment system 1 over time causes the pet food to be dispensed at various locations.

The spatial sensors 24 are configured to detect objects in the environment surrounding the robotic pet accompaniment system 1. In particular, the spatial sensors 24 are operable to detect the presence of obstacles over the underlying surface that can obstruct the displacement of the robotic pet accompaniment system 1 over the surface.

In one example embodiment, the spatial sensors 24 include a plurality of distance-enabled sensors that are each enabled to detect the presence of an obstacle and determine the distance of that obstacle from the sensor. For example, the distance-enabled sensors may each be a time-of-flight sensor, such as an ultrasound sensor. A plurality of distance-enabled sensors can be positioned and oriented on the housing 40 of the robotic pet accompaniment system 1 so as to detect the presence and determine the distance of each of one or more obstacles in various directions within the environment surrounding the robotic pet accompaniment system 1.

The spatial sensors 24 may further include a plurality of presence sensors that are each capable of detecting the presence of an obstacle when that obstacle is within a given range of the sensor, but are not capable of determining a distance to that obstacle. For example, presence sensors may include a plurality of infra-red sensors. The presence sensors can be positioned and oriented on the housing 40 of the robotic pet accompaniment system 1 so as to detect the nearby presence of one or more obstacles in various directions within the environment surrounding the robotic pet accompaniment system 1. The nearby obstacles may include obstacles lying on top of the underlying surface and/or discontinuities in the underlying surface (ex: stairs dropping to a lower floor).

The robotic pet accompaniment system 1 may include an audio-visual subsystem 42 having one or more audio elements and/or one or more visual elements. The audio element (ex: speaker) is operable to emit an audio signal, such as a sound or piece of music. The visual element (ex: display device, light emitting device) is operable to emit a visual signal, such a turning on a light emitting device, changing colors, or displaying a graphic. The audio signal and/or visual signal can be perceived by a pet and can trigger a reaction in the pet.

The controller 32 is operatively connected to the spatial sensors 24, the displacement subsystem 8, the food dispenser 16, and the audio-visual subsystem 42 (if any) to receive data therefrom and transmit control signals thereto. The controller described herein may be implemented in hardware or software, or a combination of both. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

More particularly, the controller 32 is configured to receive sensed data from the spatial sensors 24 pertaining to the presence (and distance) of obstacles in the environment surrounding the robotic pet accompaniment system 1. The controller 32 is configured to control the operation of the displacement subsystem 8 based on the received sensed data. For example, the displacement subsystem 8 is controlled to be displaced towards locations that are devoid of obstacles, while also avoiding nearby obstacles.

It will be appreciated that the combination of the spatial sensors 24, displacement subsystem 8 and the controller 32 allows the robotic pet accompaniment system 1 to be autonomously displaceable. “Autonomously displaceable” herein refers to the robotic pet accompaniment system 1 being capable of being displaced over the underlying surface without requiring human user input and in which the system 1 is capable of performing a degree of automatic avoidance of collision with obstacles on the underlying surface.

The controller 32 is configured to control operation of the food dispenser 16. For example, the controller 32 can control the food dispenser 16 to dispense food according to one or more predetermined rules.

The controller 32 may also be configured to control the audio-visual subsystem 42 to emit an audio signal and/or a visual signal. An audio signal and/or visual signal may be emitted in response to a condition sensed by the spatial sensors 24 (ex: occurrence of a collision with an obstacle). An audio signal and/or visual signal may also be emitted according to one or more predetermined rules. The emitting of the audio signal and/or visual signal may be linked with the dispensing of food from the food dispenser 16.

Various components of the robotic pet accompaniment system 1 can be controlled and operated according to a combination of preconfigured rules and user-configured rules. For example, the robotic pet accompaniment system 1 can be operated in a standby mode in which it is not being displaced nor dispensing pet food. The robotic pet accompaniment system 1 can intermittently awaken from its standby mode. The robotic pet accompaniment system 1 can be programmed by a user (ex: using a device in wireless communication with the system 1) to set a schedule at which the robotic pet accompaniment system 1 awakens from its standby mode. When awakening from the standby mode, the audio-visual subsystem 42 can be controlled to emit an audio signal and/or a visual signal to attract the attention of a pet.

After awakening from the standby mode, the robotic pet accompaniment system 1 enters a dispensing mode in which it executes a displacement and dispensing routine. According to this routine, the robotic pet accompaniment system 1 may be displaced along an itinerary, which can be preprogrammed by a user. While being displaced along the itinerary, the food dispenser 16 is intermittently controlled to dispense food (and the audio-visual subsystem 42 is controlled to emit the audio signal and/or visual signal at each instance of dispensing food). The number of times that the food is dispensed can also be programmed by a user.

After at least one of the instances of dispensing of food, the displacement subsystem 8 may be controlled to displace the robotic pet accompaniment system 1 away by a predetermined distance from the location that the dispensing occurred. This distance may be in a range of approximately 20 cm to approximately 80 cm. In one example setting, the distance may be approximately 40 centimeters. The camera 106 may then be operated to capture an image of the location that the dispensing occurred (and where the pet will likely be to eat the food just dispensed).

Upon completing the displacement and dispensing routine, the robotic pet accompaniment system 1 can return to its standby mode. A typical displacement and dispensing routine may last approximately 5 minutes up to approximately 60 minutes. In many situations, the displacement and dispensing routine may last approximately 10 minutes to approximately 20 minutes. In one example setting, the displacement and dispensing routine may last about 15 minutes.

During a displacement and dispensing routine, the controller 32 can be configured to cause the robotic pet accompaniment system 1 to emit an interactive signal at substantially the same time at each instance when the food dispenser subsystem 16 is operated to dispense food. The interactive signal can be an audio signal and/or video signal emitted by the audio-visual subsystem 42. Alternatively, or additionally, the interactive signal can be a particular sequence of movements of the robotic pet accompaniment system 1 caused by operation of the displacement subsystem 8, such as spinning in place about itself.

Emitting the interactive signal at substantially the same time includes emitting the signal within a short time window before the dispensing of food, emitting the signal during the dispensing of food, and/or emitting the signal within a short time window after the dispensing of food. The time window before or after the dispensing of food should be of sufficiently short duration such that the pet can make an association between the occurrence of the interactive signal and an instance of dispensing of food.

The predetermined rules that define how food is dispensed can be programmed by a user (ex: using a device in wireless communication with the system 1). The user may define a food dispensing time interval (i.e. the duration of time over which the robotic pet accompaniment system 1 is to operate autonomously), the number of dispensing and displacement routines to be executed during the dispensing time interval, the number of food dispensing instances within each displacement routine, distance of displacement and/or the amount of food to be dispensed. The controller 32 can then control the various subsystems 8, 16, 24, 42 of the robotic pet accompaniment system 1 to dispense this amount of food over the food dispensing time interval.

In one example embodiment, the controller can be configured to dispense the user-inputted dispensing amount of food in equal portions at regularly spaced time points over the dispensing time interval. The spacing in time and the portions of food can be based on time or on distance traveled.

For example, a user may define a dispensing time interval of 8 hours and 200 grams of food to be dispensed. The user may also define displacement routines and 2 food dispensing instances per routine. Accordingly, the robotic pet accompaniment system can be controlled to execute a displacement and dispensing routine each hour (8 hours/8 displacements) and dispense 12.5 grams of food in each food dispensing instance within every dispensing routine.

For example, a user may define a time dispensing time interval of 8 hours, 200 grams of food to be dispensed, and a total displacement time of 80 minutes. The number of displacement routines (ex: 8 displacement) and number of dispensing instances (ex: two dispensing instances) can also be defined. Accordingly, the robotic pet accompaniment system can be controlled to execute a displacement and dispensing routine each hour, each routine lasting 10 minutes and execute a dispensing instance every 5 minutes within each displacement and dispensing routine in which 12.5 grams of food is dispensed in each instance.

In some example embodiments, one or more predefined set of rules can be stored, and the user can select one of the desired predefined set of rules to be applied. The set of rules can be appropriately selected based on specie, breed, size, and/or age of the pet.

Referring now to FIGS. 2A to 2F, therein illustrated is a top plan view, a perspective view, a right elevation view, a front elevation view, a left elevation view and a bottom plan view, respectively, of an assembled robotic pet accompaniment system 1 according to an example embodiment. The view of FIGS. 2A to 2F mainly show the housing 40 and components visible at the exterior of the housing 40.

The assembled robotic pet accompaniment system 1 includes a first set 24a of sensors located at a front of the housing 40. The first set 24a of sensors includes an emitter 48a and receiver 48b of a front-facing distance-enabled sensor, which is configured to detect the presence and to determine the distance of objects in a direction ahead of the front side 52 of the robotic pet accompaniment system 1. The first set 24a of sensors further includes a first presence sensor 56 that is configured to detect the presence of nearby objects immediately ahead of the front side 52 of the robotic pet accompaniment system 1.

Referring to FIG. 2C, the robotic pet accompaniment system 1 further includes a second set 24b of at least one sensor located at a right side 60 of the housing 40. The second set 24b of sensors includes an emitter 64a and receiver 64b of a right-facing distance-enabled sensor, which is configured to detect the presence and determine the distance of objects in a direction ahead of the right side 60 of the robotic pet accompaniment system 1.

Referring to FIG. 2E, the robotic pet accompaniment system 1 further includes a third set 24c of sensors located at a left side 68 of the housing 40. The third set 24c of sensors includes an emitter 72a and receiver 72b of a left-facing distance-enabled sensor, which is configured to detect the presence and determine the distance of objects in a direction ahead of the left side 68 of the robotic pet accompaniment system 1.

The robotic pet accompaniment system 1 further includes at least one downwardly-facing presence sensor for detecting an obstacle corresponding to a discontinuity in the underlying surface. In the illustrated example, and as illustrated, a first downwardly facing presence sensor 80a is positioned rightwards and frontwards of a center of the housing 40 and a second downwardly facing presence sensor 80b is positioned leftwards and frontwards of a center of the housing 40.

The robotic pet accompaniment system 1 may also include an accelerometer for determining an acceleration of the system 1 in one or more directions. The acceleration information may be received at the controller 32, and the displacement subsystem 8 can be controlled in response thereto.

Continuing with FIGS. 2A to 2F, according to the illustrated example, the displacement subsystem 8 includes a non-steerable wheels 88a, 88b, each oriented in a front-to-back direction of the housing 40. A first electric motor drives the first non-steerable wheel 88a and a second electric motor drives the second non-steerable wheel 88b. At least one current sensor can be provided to sense a current flowing through one or more of the motors. A change in current in one of the motors can also indicate the robotic pet accompaniment system 1 colliding with an obstacle.

The displacement subsystem 8 further includes at least one swivel caster 96 which provides stability during turning of the robotic pet accompaniment system 1.

The controller 32 is operable to control displacement by causing the wheels 88a, 88b to be driven in the same direction (to displace forwardly or backwardly) or in opposite directions (to turn the robotic pet accompaniment system 1 to the left or the right).

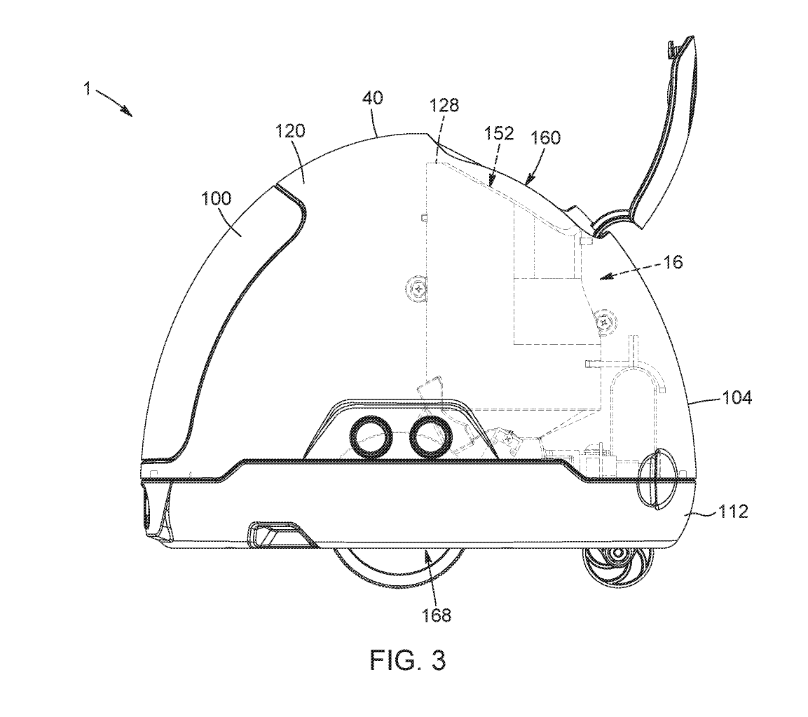

Referring now FIG. 3, therein illustrated is a transparent elevation view of the robotic pet accompaniment system 1. The housing 40 includes a hollow upper cover 104 that is coupled to a chassis 112 supporting the displacement subsystem 8. The cover 104 and the chassis 112 define together an inner chamber 120. The cover 104 may have a generally domed shape. The domed-shaped cover 104 can have a substantially smooth, curved surface that is free of discontinuities (ex: corners). The smooth, curved surface makes it more difficult for a pet to grip the robotic pet accompaniment system 1 (ex: from biting a discontinuity or grasping a discontinuity) and cause the system 1 to tip over.

The food dispenser 16 may be located within the inner chamber 120. In the illustrated example, the food dispenser 16 is entirely housed within the inner chamber 120. The inner chamber 120 is substantially closed by the housing 40, in that components housed within the housing 40 are not accessible (except specifically defined openings of the housing 40, such as refill opening 160 and dispensing opening 168).

Referring now to FIGS. 2A to 2F and FIG. 3 together, the robotic pet accompaniment system 1 includes a visor 100, which may be located on a frontal portion of the upper cover 104. The visor 100 may include one or more visual elements for emitting a visual signal. In one example embodiment, the visual element of the visor 100 can emit visual signals in the form of side-by-side shapes. These shapes resemble eyes of the robotic pet accompaniment system 1 and give a life-like appearance to the system 1.

According to one example embodiment, the robotic pet accompaniment system 1 includes an image capture subsystem, such as a camera 106. The camera 106 can be controlled by the controller 32 to capture images. For example, the camera 106 is useful to capture pictures and/or videos of the pet interacting with the robotic pet accompaniment system 1. The pictures and/or videos may be stored electronically at the robotic pet accompaniment system 1. The camera may be located near the front of the hollow upper cover 104, such as behind the visor 100. Alternatively, and as illustrated, the camera 106 may be positioned towards the rear of the robotic pet accompaniment system 1. It was observed that a pet often interacted with robotic pet accompaniment system 1 by chasing it. The rear placement of the camera 106 is effective for capturing the pet chasing the system 1.

According to an example embodiment, the robotic pet accompaniment system 1 further includes a communication subsystem, such as a wireless subsystem. The communication subsystem is operable to transmit one or more electronic data to a remote device. The electronic data may include operating conditions of the robotic pet accompaniment system 1, such as distance traveled, amount of food dispensed, etc. The electronic data may also include pictures and/or videos captured by the image capture device. A user may use a remote device, such as a computer, smartphone, tablet, or the like, to remotely view pictures and/or videos captured by the robotic pet accompaniment system 1 of their pet.

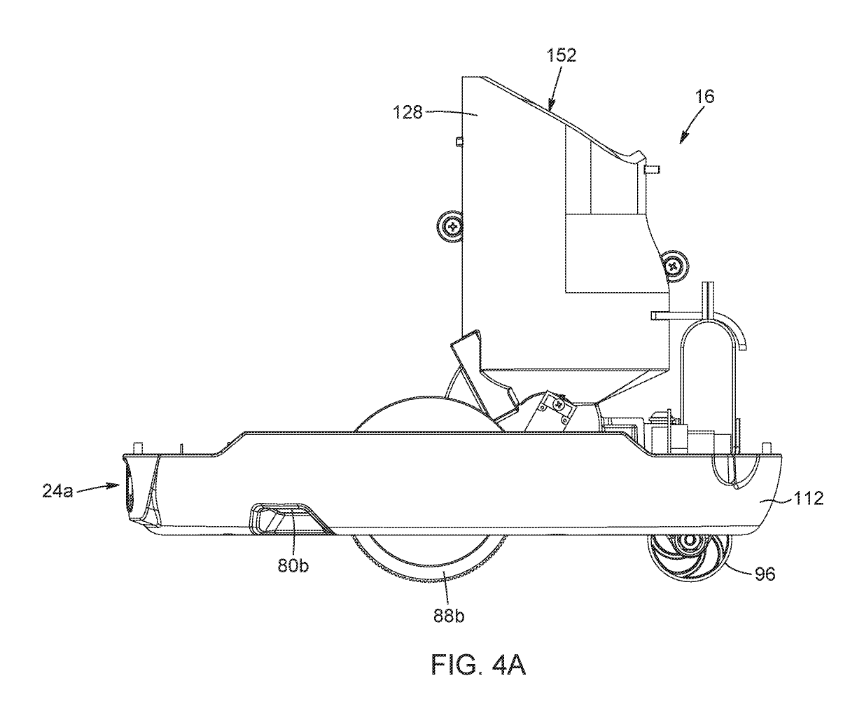

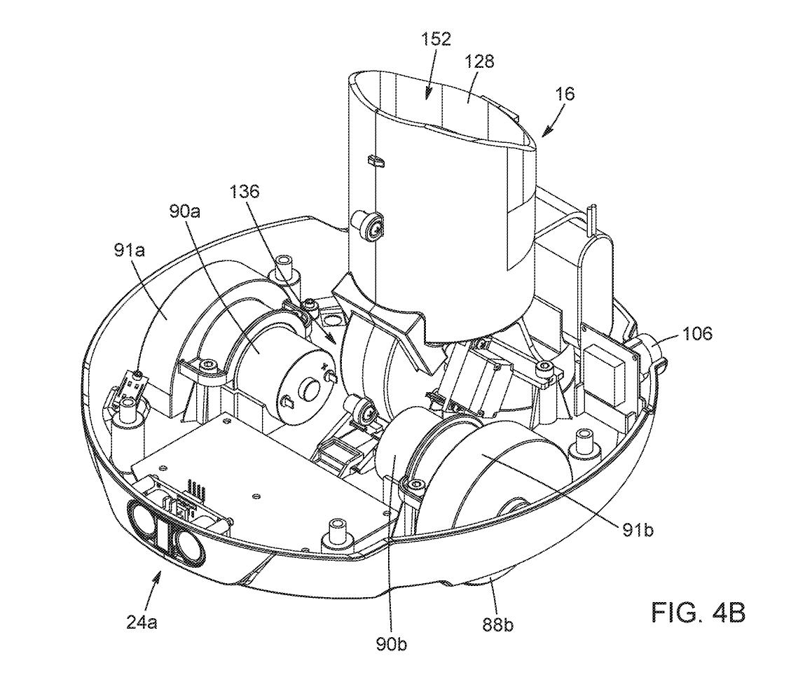

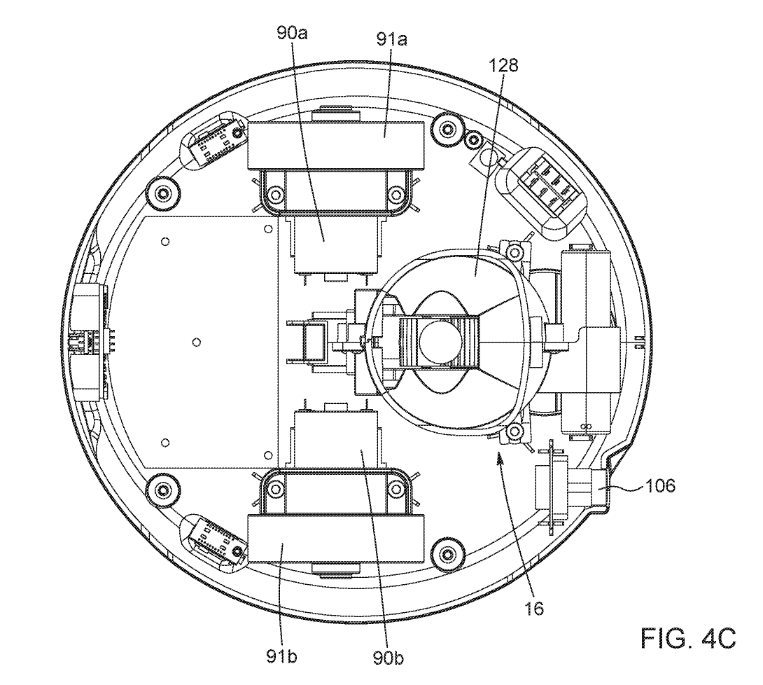

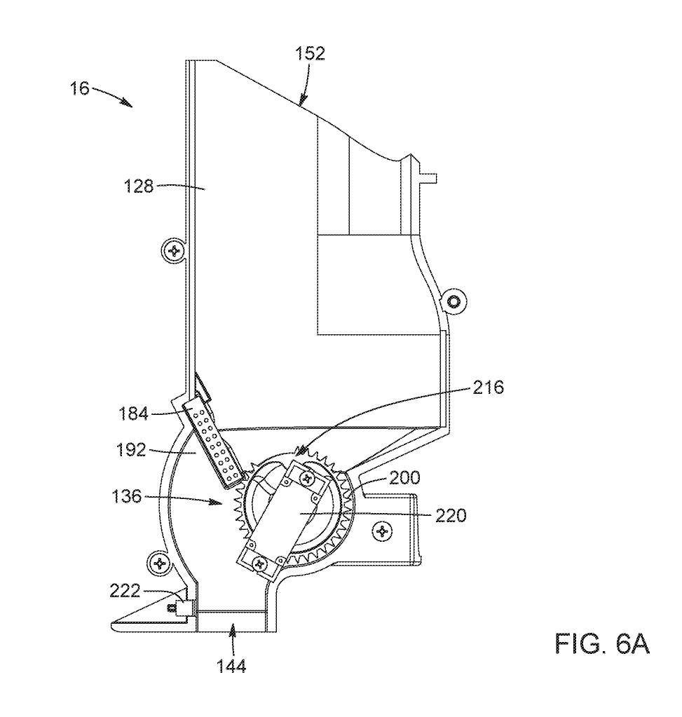

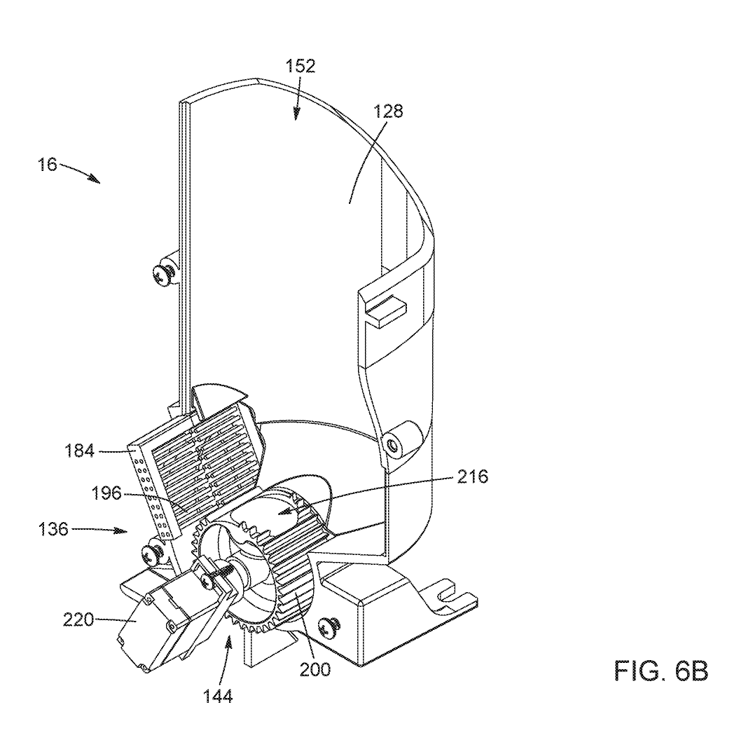

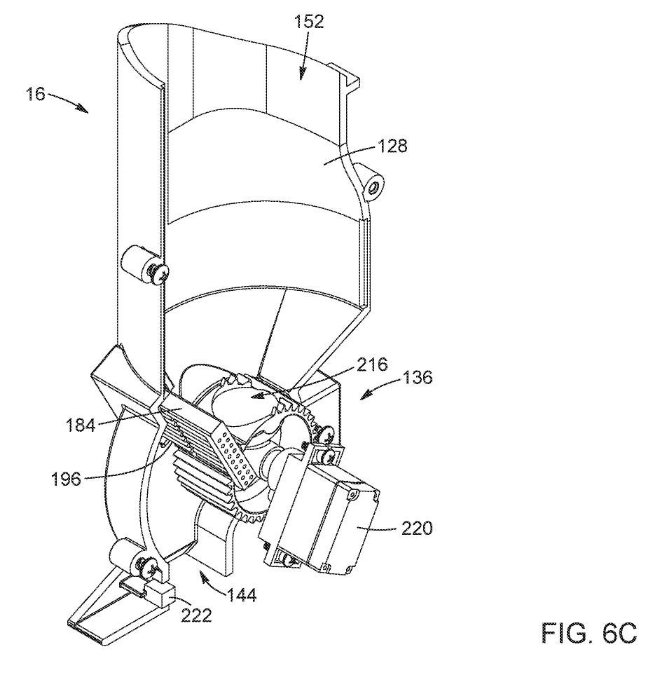

Referring to FIGS. 4A, 4B, and 4C, therein illustrated are a side elevation view, a perspective view, and a top plan view of the robotic pet accompaniment system 1 having the upper cover 104 of the housing 40 removed. The food dispenser 16 is supported on the chassis 112 of the housing 40. The food dispenser 16 includes a hopper 128, a dispensing mechanism 136 and a dispensing port 144 (FIG. 6A). The food dispenser 16 is capable of dispensing pet food of various sizes, shapes and/or density.

The hopper 128 stores the pet food to be dispensed. In the illustrated example, the hopper 128 defines a top opening 152 for receiving refills of pet food. The top opening 152 is aligned with a corresponding refill opening 160 (FIG. 3) defined in the housing 40. The dispensing mechanism 136 is configured to be selectively operated to feed pet food from the hopper 128 to the dispensing port 144. The dispensing port 144 is in communication with a dispensing opening 168 (FIG. 2F) define in the housing 40, whereby pet food received at the dispensing port 144 exits the robotic pet accompaniment system 1 through dispensing opening 168.

As described elsewhere and as illustrated in FIGS. 4A to 4C, the displacement subsystem 8 is also substantially housed within the housing 40. As illustrated, motors 90a and 90b driving the wheels 88a, 88b are housed within the housing 40 and supported by the chassis 112. In the illustrated example, wheels 88a, 88b are located within arches 91a and 91b formed in the chassis 112.

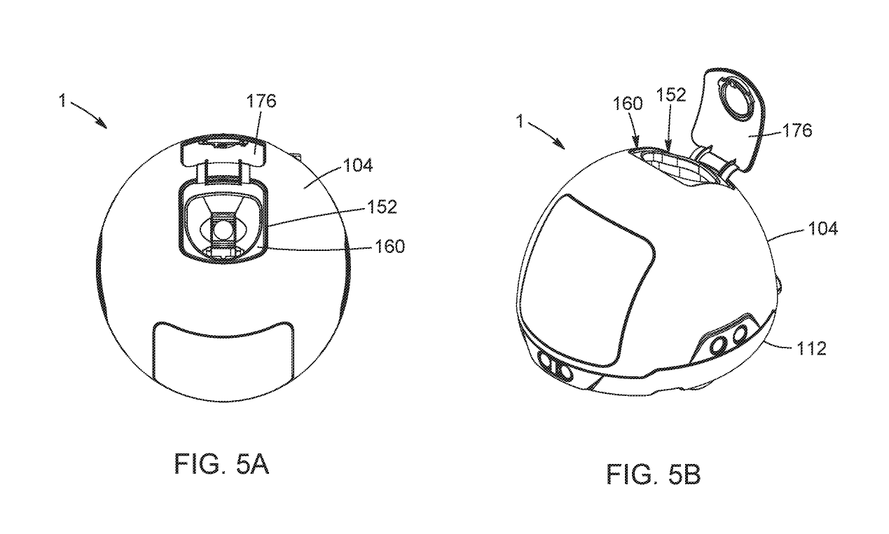

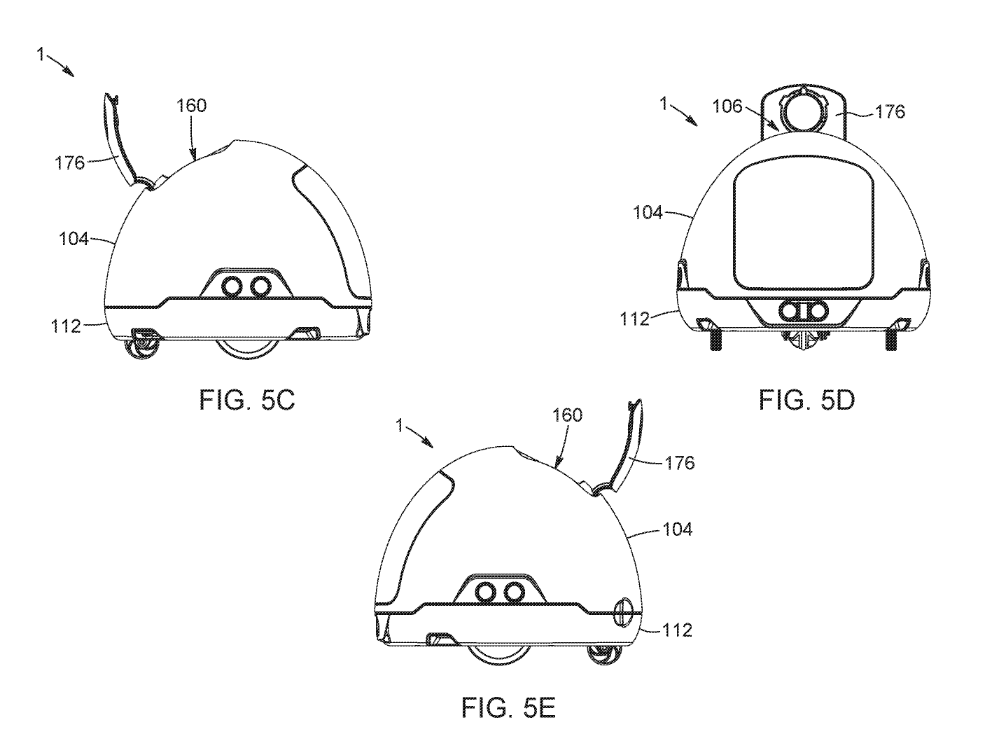

Referring back to FIGS. 5A to 5E, therein illustrated are a top plan view, a perspective view, a right elevation view, a front elevation view, and a right elevation view, respectively, of the robotic pet accompaniment system 1 according to an example embodiment in a refill (open) configuration. The upper cover 104 of the housing 40 includes a refill lid 176. Opening refill lid 176 exposes the refill opening 160, which is aligned with the top opening 152 of the hopper 128 of the food dispenser 16. A user refills the hopper 128 by stopping displacement of the robotic pet accompaniment system 1, opening the refill lid 176 to its open position and pouring the pet food through the refill opening 160 (and top opening 152) into the hopper 128 of the food dispenser 16. In a closed configuration, the refill lid 176 is superposed to the top opening 152 of the hopper 128 of the food dispenser 16 and access to the food dispenser is prevented.

Referring now to FIGS. 6A to 6C, therein illustrated a view of the food dispenser with one wall of the hopper 128 being removed, thereby providing cross-sectional view, a first partial cut-away perspective view and a second partial cut-away perspective view, respectively, of the food dispenser 16 according to an example embodiment. The dispensing mechanism 136 forms a selective barrier between the hopper 128 and the dispensing port 144.

According to the illustrated example, the dispensing mechanism 136 includes a gate 184 partially positioned over a channel 192 connecting the hopper 128 and the dispensing port 144. The gate 184 includes a plurality of bendable members 196, which capture particulate or pelletized pet food. The bendable members 196 can be one or more of natural or synthetic fibers, an elastomer material, a flexible polymer material, a spring mechanism, a levered mechanism or a pendulum.

The dispensing mechanism 136 further includes a feeder wheel 200. The feeder wheel 200 may be a toothed wheel, as illustrated. The feeder wheel 200 has a receptacle 216. The feeder wheel 200 is rotatable between a receiving position and a dispensing position. In the receiving position, the feeder wheel 200 is oriented such that its receptacle 216 is in communication with the interior of the hopper 128. Pet food stored in the hopper 128 enters the receptacle 216. An opening of the receptacle 216 is oriented upwardly such that the pet food enters the receptacle 216 from the force of gravity.

In the dispensing position, the feeder wheel 200 is rotated such that the receptacle 216 is in communication with the channel 192 and the dispensing port 144. Pet food received within the feeder wheel 200 exits the receptacle 216 into the channel 192 and further falls to the dispensing port 144. An opening of the receptacle 216 may be oriented downwardly such that the pet food exits from it into the channel 192 from a force of gravity.

The feeder wheel 200 may be actuated between its receiving position and its dispensing position by an electric motor 220 connected thereto. Actuation of the feeder wheel 200 may be controlled from control signals transmitted by the controller 32 of the robotic pet accompaniment system 1.

The bendable members 196 cooperate with the feeder wheel 200. The bending of the bendable members 196 promote (such as by pushing or biasing) the entering of pet food from the hopper 128 into the receptacle 216.

An outer circumference of the feeder wheel 200 corresponds substantially with a lower end of the gate 184 such that pet food disposed on the outer surface of the feeder wheel 200 is blocked from being dispensed during rotation of the feeder wheel 200 from its receiving position to its dispensing position. As a result, only pet food received within the receptacle 216 is dispensed. Furthermore, the bendable members 196 reduces the likelihood of food pellets being stuck in the area of the engagement of the feeder wheel 200 with the filter 184.

According to one example embodiment, and as illustrated, the food dispenser 16 further includes at least one dispensing sensor 222. The dispensing sensor 222 is configured to detect whether an amount of pet food has been dispensed through the dispensing port 144 in response to a request for dispensing food (ex: sent from the controller 32, when a dispensing condition has been reached). The dispensing sensor 222 ensures that the amount of pet food has been dispensed. If an amount of pet food is not detected by the dispensing sensor 222 in response to a request for dispensing food, the dispensing sensor 222 can send an alert to the controller 32 and the dispensing mechanism 136 can be controlled to undergo another dispensing cycle (ex: actuating the feeder wheel 200 from the receiving position to the dispensing position one more time) to attempt to dispense the amount food again.

According to one example embodiment, and as illustrated, the dispensing opening 168 is positioned on an underside of the housing 40 and within the chassis 112. Pet food arriving at the dispensing port 144 further exits the robotic pet accompaniment system 1 through the dispensing opening 168 and falls onto the underlying surface, where it becomes available to be consumed by a pet.

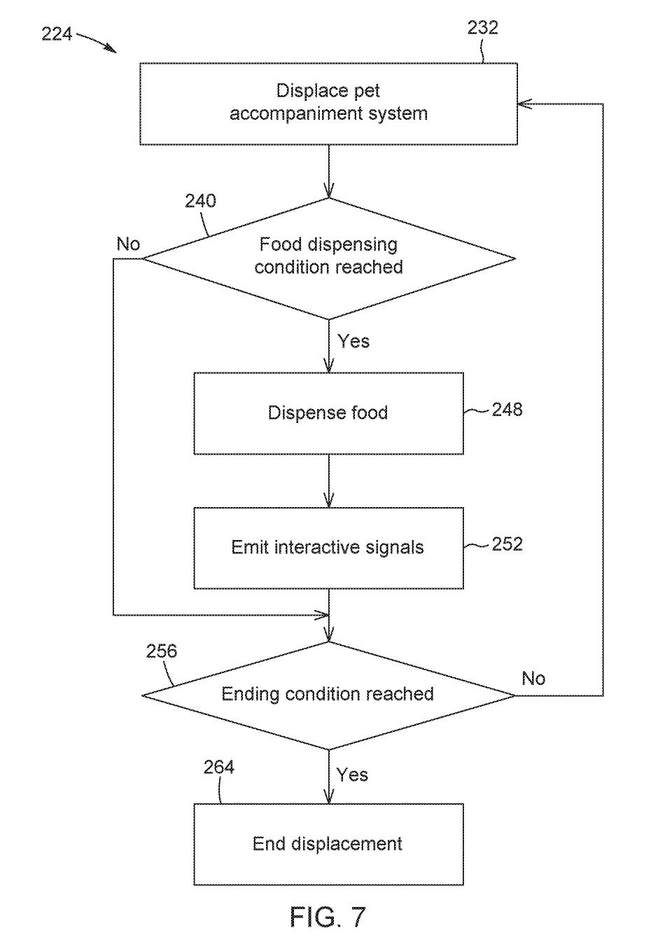

Referring now to FIG. 7, therein illustrated is a flowchart showing the operational steps of a method 224 for operating the robotic pet accompaniment system 1 according to one example embodiment. The method 224 may be carried out by the controller 32, such as by receiving and sending appropriate control signals to and from the spatial sensors 24, displacement subsystem 8 and food dispenser 16.

At step 232, the displacement subsystem 8 is controlled to cause the robotic pet accompaniment system 1 to be displaced over the underlying surface. In some embodiments, the robotic accompany system 1 can be configured to provide one or more signals, such a particular displacement movement or particular audio-visual signal(s), to indicate the robotic accompaniment system 1 starting up.

At step 240, it is determined whether a food dispensing condition has been reached. The food dispensing condition may be defined by predetermined rules stored (ex: as computer-executable instructions) at the controller 32.

If the food dispensing condition has been reached, the food dispenser 16 is controlled so that pet food is distributed therefrom at step 248. For example, a control signal is transmitted to the dispensing mechanism 136 of the food dispenser 16 to cause the feeder wheel to be actuated from the receiving position to the dispensing position.

In an example embodiment, and illustrated in FIG. 7, at least one subsystem of the robotic pet accompaniment system 1 can be optionally controlled, at step 252, to emit at least one interactive signal in response to a food dispensing condition being reached.

The interactive signal signaling the dispensing of food can be a particular sequence of movements of the robotic pet accompaniment system 1, in which case the displacement subsystem 8 is controlled to provide the movement. For example, the displacement subsystem 8 is controlled to cause the robotic pet accompaniment system 1 to spin in place prior to dispensing the food. Additionally, or alternatively, the interactive signal signaling the dispensing of food can be a particular audio signal and/or video signal, in which case the audio-visual subsystem 42 is controlled to emit the one or more signals with the dispensing of the food. The audio-visual signal can include turning on light emitting device(s) or changing the graphic displayed by the displace device (ex: displaying eyes on the visor 100 and/or changing the color of the graphic). The interactive audio-visual signal may be distinctive from all other audio-visual signals emitted by the audio-visual subsystem 42 so that a user (human and/or pet) can associate the distinctive interactive audio-visual signal with the dispensing of food.

The robotic pet accompaniment system 1 may be configured to emit an interactive signal signaling dispensing of food only after the sensors 222 have detected that an amount of food has indeed been dispensed through the dispensing port 144.

After dispensing the food, or if a food dispensing condition has not been reached, the method 224 proceeds to step 256 to determine whether an ending condition reached. The ending condition corresponds to a condition in which the robotic pet accompaniment system 1 should stop operating, such as having dispensed all the food within the food dispenser 16, having reached the end of a preprogrammed operating schedule, or receiving a user command to stop operating.

If an ending condition has not been reached, the method 224 continues the displacement and the selective dispensing of food.

If an ending condition has been reached, operation of the robotic pet accompaniment system 1 is ended at step 264.

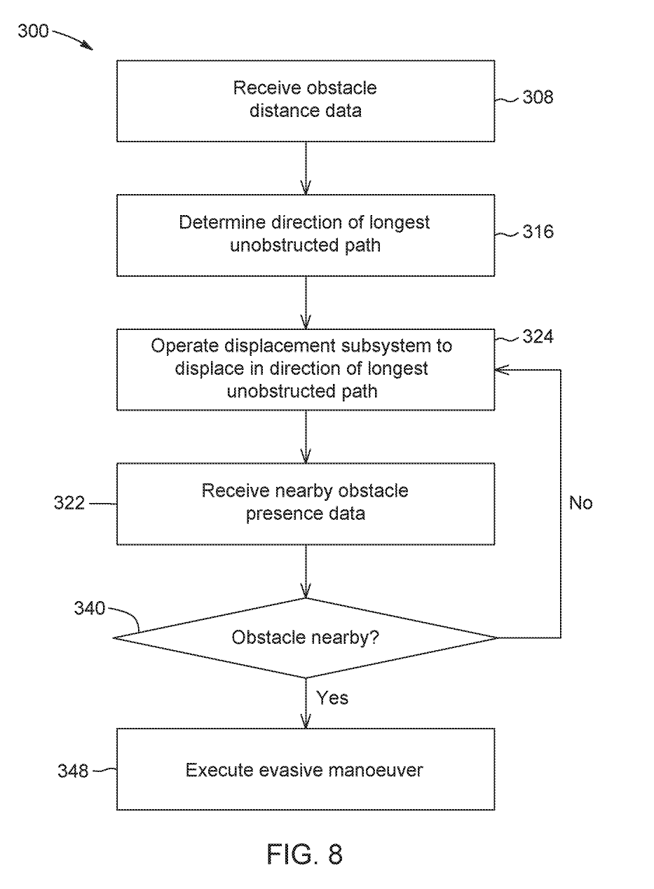

Referring now to FIG. 8, therein illustrated is a flowchart showing the operational steps of a method 300 for displacing the robotic pet accompaniment system 1 according to an example embodiment. The method 300 may correspond to the step 232 of the displacing the robotic pet accompaniment system 1 of method 224.

At step 308, sensed data is received from the distance-enabled sensors of the spatial sensors 24. The received data can indicate presence and distance of obstacles in a plurality of directions surrounding the robotic pet accompaniment system 1.

In the illustrated example, presence and distance data is received from each of the front-facing distance-enabled sensor (of the first set 24a of sensors and having emitter 48a and receive 48b), right-facing distance-enabled sensor (of the second set 24b and having emitter 64a and receiver 64b), and left-facing distance-enabled sensor (of the third set 24c and having emitter 72a and receiver 72b). Accordingly, the sensed data indicates the distance of obstacles away from the robotic pet accompaniment system 1 in a direction to the left, in a direction to the right, and in a direction towards the front.

At step 316, a direction of displacement is chosen based on the distance of obstacles in the plurality of directions around the robotic pet accompaniment system 1 indicated in the sensed data received at step 308. In one example embodiment, it is determined which direction around the robotic pet accompaniment system 1 has the longest unobstructed path. This direction corresponds to the one in which the nearest obstacle in that direction is further away than the nearest obstacle in any other direction.

At step 324, the displacement subsystem 24 is controlled to cause the robotic pet accompaniment system 1 to be displaced in the direction chosen at step 316. For example, the displacement subsystem 24 is displaced in the direction having the longest unobstructed path.

At step 332, sensed data is received from presence sensors of the spatial sensors 24, this sensed data indicating detected presence of one or more nearby obstacles. Such nearby obstacles may have been missed by the distance-enabled sensors. The sensed data may be received from the presence sensors immediately prior to displacing the robotic pet accompaniment system 1 at step 324. The sensed data may also be received during displacement of the robotic pet accompaniment system 1.

At step 340, it is determined whether a nearby obstacle has been sensed by a presence sensor. If an obstacle has not been sensed nearby, displacement of the robotic pet accompaniment system 1 in the chosen direction (ex: the direction of the longest unobstructed path) is continued and sensing of nearby obstacles is also continued.

If an obstacle has been sensed nearby, the displacement subsystem 8 is controlled at step 348 to perform an evasive manoeuver to evade the sensed obstacle. A plurality of evasive manoeuvers may be preconfigured and the one of the preconfigured evasive manoeuvers is selected therefrom based on the location of the sensed obstacle (ex: based on which of the presence sensors detected the nearby obstacle).

Where an obstacle has been encountered or a collision has occurred, the audio-visual subsystem 42 can be controlled to emit at least one audio-visual signal indicating such an occurrence. For example, the eyes displayed on the visor 100 can turn red to simulate an emotion of frustration.

Subsequent to performing the evasive manoeuver, displacement of the robotic pet accompaniment system 1 can be continued. The robotic pet accompaniment system 1 may continue to be displaced in the direction of the robotic pet accompaniment system 1. Alternatively, more sensed data is received from the distance-enabled sensors and a new direction of displacement is determined. Furthermore, displacing the robotic pet accompaniment system 1 in the direction of the longest unobstructed path causes the system (and the pet chasing the system) to cover longer distances.

According to one example embodiment, the robotic pet accompaniment system 1 further includes a tilt sensor operable to sense a tilt angle of the housing 40. The tilt sensor may be implemented in part, or wholly, by the accelerometer. Other tilt sensors known in the art, such as a gyroscope, may also be used. The controller 32 can be configured to receive or monitor the tilt angle measured by the tilt sensor. The measured tilt angle is compared against a predetermined tilt angle threshold. The controller 32 can be further configured to control the displacement subsystem to stop the displacement upon detecting that the measured tilt angle has exceeded the predetermined tilt angle threshold. The controller 32 can also stop the food dispenser upon detecting the measured tilt angle exceeding the predetermined tilt angle threshold. The emission of an interactive signal, such as emitting an audio and/or video signal can also be stopped upon detecting the measured tilt angle exceeding the predetermined tilt angle threshold. It will be appreciated that stopping the operation of components of the robotic pet accompaniment system 1 is useful to protect components of the system 1.

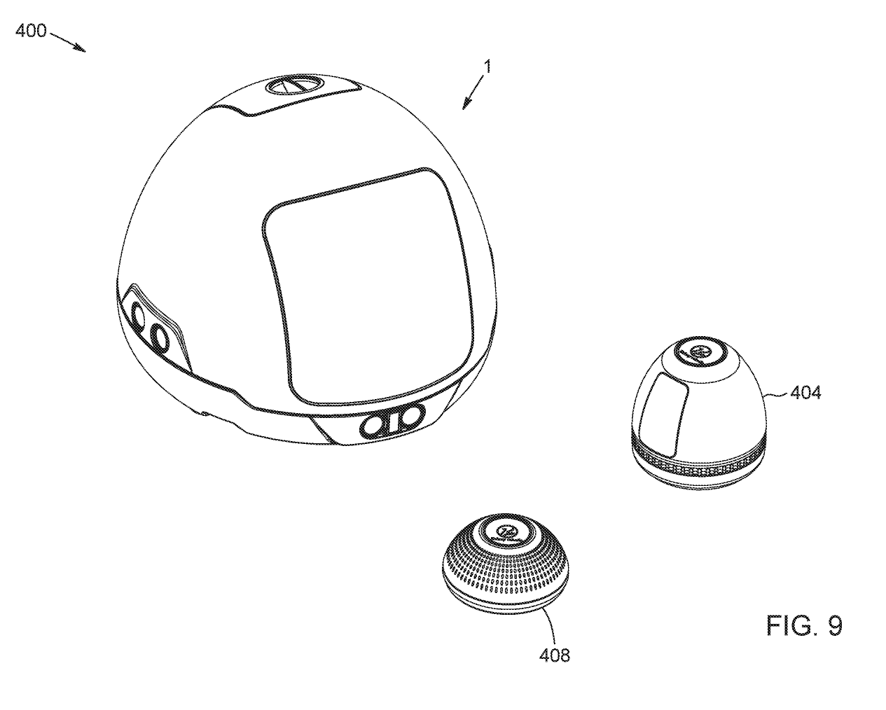

Referring now to FIG. 9, therein illustrated is a combined pet accompaniment system 400 according to an example embodiment. The accompaniment system 400 includes the robotic pet accompaniment system 1 as described herein according to various example embodiments, an image capture device 404 and/or an audio activation device 408. It will be understood that each of the image capture device 404 and the audio activation device 408 can operate independently with the pet accompaniment system 400. Alternatively, the image capture device 404 and the audio activation device 408 can operate together with the robotic pet accompaniment system 1.

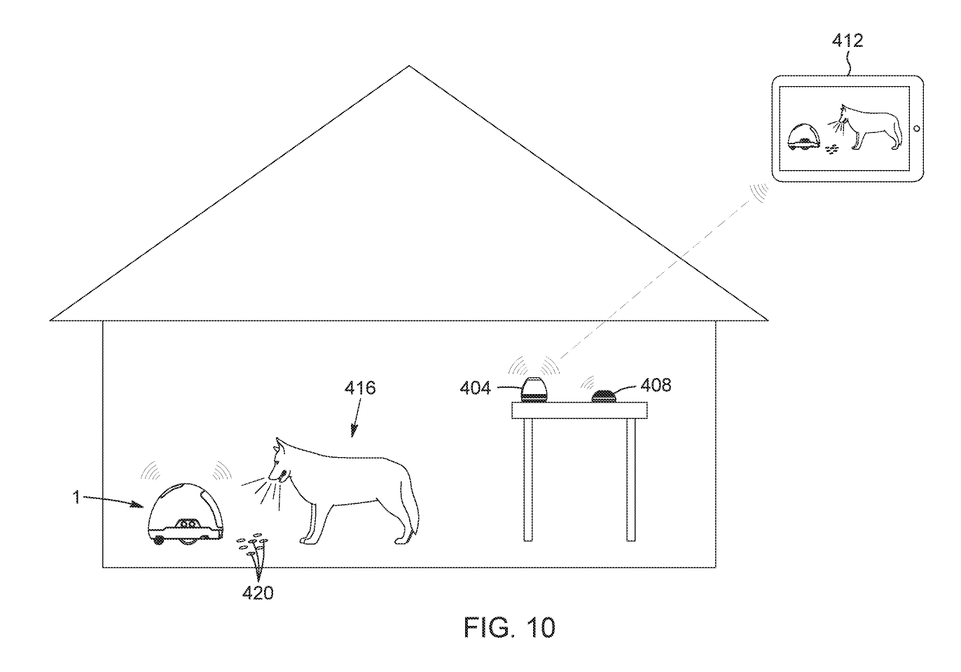

The image capture device 404 includes a camera for capturing images and/or videos of a scene. The image capture device 404 further includes at least one communication device for wireless data communication with the robotic pet accompaniment system 1. The at least one communication device may also be operable to communicate with a user device 412 (FIG. 10) over a wide area network, such as the Internet. Upon the robotic pet accompaniment system awaking from its standby mode, a capture activation signal can be emitted therefrom and be received at the image capture device 404. Upon receiving the capture activation signal, the image capture device 404 begins operating to capture images and/or videos of the scene from its camera. The capture images can be stored locally within a memory device of the image capture device 404, uploaded over the wide area network to the user device 412, or uploaded and stored at a remote location, such as a cloud storage. In use, the image capture device 404 should be appropriately position so that the captured scene corresponds to an area where the robotic pet accompaniment system 1 will be displaced and the pet will be stimulated.

The audio activation device 408 includes a microphone for capturing sounds in the environment surrounding it. The audio activation device 408 further includes at least one communication device for wireless data communication with the robotic pet accompaniment system 1. The audio activation device 408 monitors the captured signal to detect a sound corresponding to a sound emitted from the pet (ex: a bark from a dog). According to one example embodiment, upon detecting the sound, the audio activation device 408 can transmit a displacement activation signal, which is to be received at the robotic pet accompaniment system 1. The robotic pet accompaniment system 1 can be configured to awaken from its standby mode upon receiving the displacement activation signal and begin a displacement routine. As described above, upon having traveled a given distance, the food dispenser 16 can be controlled to dispense an amount of food.

According to an alternate example embodiment, upon detecting the sound, the audio activation device 408 can transmit an alert signal to the user device 412, which informs the user that the pet has been emitting sounds. The user can then interact with the user device 412 to send a displacement activation signal therefrom to the robotic pet accompaniment system 1. As described above, the robotic pet accompaniment system 1 can be configured to awaken from its standby mode upon receiving the displacement activation signal and begin a displacement routine.

According to configurations where both the image capture device 404 and the audio activation device 408 are provided, the displacement activation signal that causes the robotic pet accompaniment system 1 to begin its displacement routine will also cause the robotic pet accompaniment system 1 to transmit a capture activation signal to further cause the image capture device 404 to begin capture images and/or video of the scene.

Referring now to FIG. 10, therein illustrated is a schematic diagram showing an operating environment of the combined pet accompaniment system according to an example embodiment. The robotic pet accompaniment system 1 is deployed over the floor (the underlying surface) of home. The robotic pet accompaniment system 1 is to be displaced over an area where a pet 416 can also be present. Food pellets 420 are dispensed by the robotic pet accompaniment system 1 over time.

Continuing with FIG. 10, the image capture device 404 is placed at a location and oriented in a direction such that a scene captured by its camera encompasses the area where the robotic pet accompaniment system 1 will be displaced. In the illustrated example, the image capture device 404 is placed atop a table near the robotic pet accompaniment system 1. As described elsewhere herein, the robotic pet accompaniment system 1 transmits a capture activation signal upon awakening from its standby mode to begin a displacement and dispensing routine. Upon receiving this capture activation signal, the camera of the image capture device 404 is controlled to begin capturing images and/or video of the scene for an interval of time. The images and/or video should contain footage of the pet 416 interacting with the robotic pet accompaniment system 1 as the latter undergoes its displacement and dispensing routine.

FIG. 10 also illustrates the audio activation device 408 placed in proximity of the area where the robotic pet accompaniment system 1 will be displaced. The audio activation device 408 should be positioned at a location such that it can discern a sound emitted from a pet (ex: a bark from a dog). In the illustrated example, the audio activation device 408 is also placed atop the table near the robotic pet accompaniment system. As described elsewhere herein, the audio activation device 408 transmits a displacement activation signal to the robotic pet accompaniment system 1 upon detecting a sound emitted from the pet. Alternatively, the audio activation device 408 transmits an alert signal to the user device 412 upon detecting a sound emitted from the pet and the user can interact with the user device 412 to send a displacement activation signal to the robotic pet accompaniment signal. Upon receiving this displacement activation signal, the robotic pet accompaniment system 1 awakens from its standby mode and begins a displacement and dispensing routine. The robotic pet accompaniment system 1 may also transmit a capture activation signal to cause the image capture device 404 to begin capturing images and/or video of the scene.

While FIG. 10 illustrates both the image capture device 404 and the audio activation device 408, it will be understood, and as described elsewhere herein, that each the image capture device 404 and the audio activation device 408 may be used separately with the robotic pet accompaniment system 1.

It was observed that the robotic pet accompaniment system 1 described herein according to various example embodiments is effective at stimulating pets. A pet is stimulated from the combination of the displacement of the robotic pet accompaniment system 1 and the intermittent dispensing of pet food. The pet quickly learns that the food is dispensed from the system 1, which attracts the attention of the pet. The displacement of the robotic pet accompaniment system 1 keeps the pet active, as the pet is motivated to follow the system 1 in order to get the dispensed food.

It was further observed that according to embodiments described herein in which at least one interactive signal is emitted immediately prior to, during, or immediately after the dispensing food, this interactive signal creates a Pavlovian reaction in a pet, which further heightens stimulating of the pet. The pet sensing the interactive signal will become excited and will engage in chasing the robotic pet accompaniment system 1.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A robotic pet accompaniment system comprising:
a housing defining a substantially closed chamber having a food dispensing opening;
a displacement subsystem substantially housed within the housing and configured for displacing the housing over an underlying surface; and
a food dispenser located within the substantially closed chamber and being displaced with displacement of the housing and configured for selectively dispensing pet food through the food dispensing opening onto the underlying surface.

2. The robotic pet accompaniment system of claim 1, wherein the food dispenser comprises a hopper for storing pet food to be dispensed; and
wherein the housing comprises a refill opening aligned with the hopper and a lid configurable in a closed configuration to prevent access to the food dispenser by being superposed to the refill opening, whereby pet food is receivable within the hopper through the refill opening when the lid is in an open configuration.

3. The robotic pet accompaniment system of claim 2, wherein the housing comprises a chassis and a domed cover defining together the substantially closed chamber, the displacement subsystem being supported by the chassis; and
wherein the pet food dispensing opening is formed in the chassis and wherein the domed cover comprises the lid and the refill opening.

4. The robotic pet accompaniment system of claim 1, further comprising a plurality of spatial sensors for detecting the presence of objects in an environment surrounding the housing.

5. The robotic pet accompaniment system of claim 4, wherein the spatial sensors comprise a plurality of distance-enabled sensors and a plurality of presence sensors.

6. The robotic pet accompaniment system of claim 5, wherein a first distance-enabled sensor is configured for detecting obstacles in a direction to a front of the housing, a second distance-enabled sensor is configured for detecting obstacles in a direction to a left side of the housing and a third distance-enabled sensor is configured for detecting obstacles in a direction to a right side of the housing.

7. The robotic pet accompaniment system of claim 5, further comprising a controller operatively connected to the displacement subsystem, the controller configured for:
receiving sensed data from the plurality of distance-enabled sensors of the spatial sensors, the sensed data indicating presence and distance of obstacles in the environment surrounding the housing;
determining a direction of displacement based on the received sensed data; and
controlling the displacement subsystem to cause displacement of the housing in the determined direction of displacement.

8. The robotic pet accompaniment system of claim 7, wherein a direction of the longest unobstructed path is determined as the direction of displacement.

9. The robotic pet accompaniment system of claim 4, further comprising a controller operatively connected to the displacement subsystem and to the food dispenser, the controller configured for:
receiving sensed data from the plurality of spatial sensors;
determining a direction of displacement based on the received sensed data; and
controlling the displacement subsystem to cause displacement of the housing in the determined direction of displacement;
controlling the food dispenser to dispense an amount of food onto the underlying surface at a given location; and
controlling the displacement subsystem to displace the housing away from the given location immediately after dispensing the amount of food.

10. The robotic pet accompaniment system of claim 4, further comprising a controller operatively connected to the displacement subsystem and to the food dispenser; the controller configured for:
receiving sensed data from the plurality of spatial sensors;
determining a direction of displacement based on the received sensed data; and
controlling the displacement subsystem to cause displacement of the housing in the determined direction of displacement;
controlling the robotic pet accompaniment system to emit at least one interactive signal at substantially the same time as each dispensing of food onto underlying surface.

11. The robotic pet accompaniment system of claim 4, further comprising a tilt sensor operable to monitor a tilt angle of the housing and a controller operatively connected to the displacement subsystem and the tilt sensor, the controller configured for:
receiving sensed data from the plurality of spatial sensors;
determining a direction of displacement based on the received sensed data; and
controlling the displacement subsystem to cause displacement of the housing in the determined direction of displacement;
receiving a tilt angle measured by the tilt sensor; and
controlling the displacement subsystem to stop the displacement upon detecting the tilt angle exceeding a predetermined tilt angle threshold.

12. The robotic pet accompaniment system of claim 7, further comprising a communication module; and
wherein the controller is configured to receive, via the communication module, a user-inputted food dispensing amount and a user-inputted food dispensing time interval, and to control the food dispenser to dispense the user-inputted dispensing amount of food over the food dispensing time interval.

13. The robotic pet accompaniment system of claim 12, wherein the controller is configured to dispense the user-inputted food dispensing amount of food in equal portions of the amount at regularly spaced time points over the user-inputted dispensing time interval.

14. A method for controlling a robotic pet accompaniment system having a displacement subsystem operable to displace the robotic pet accompaniment system and a food dispenser for selectively dispensing food, the method comprising:
controlling the displacement subsystem to cause displacement of the robotic pet accompaniment system over an underlying surface; and
controlling the food dispenser to intermittently dispense food onto the underlying surface.

15. The method of claim 14, wherein the robotic pet accompaniment system further comprises a plurality of distance-enabled spatial sensors and a housing, the method further comprising:
receiving sensed data from the plurality of distance-enabled sensors of the spatial sensors, the sensed data indicating presence and distance of obstacles in an environment surrounding the housing; and
determining a direction of displacement based on the received sensed data; and
wherein the displacement subsystem is controlled to cause displacement in the determined direction of displacement.

16. The method of claim 15, wherein a direction of the longest unobstructed path is determined as the direction of displacement.

17. The method of claim 14, further comprising emitting at least one interactive signal at substantially the same time as each dispensing of food onto the underlying surface.

18. The method of claim 14, wherein after dispensing an amount of food onto the underlying surface at a given location, immediately displacing the robotic pet accompaniment system away from the given location.

19. The method of claim 14, further comprising:
monitoring a tilt angle of the robotic pet accompaniment system; and
controlling the displacement subsystem to stop operation of the displacement subsystem upon detecting the tilt angle exceeding a predetermined tilt angle threshold.

20. The method of claim 14, further comprising:
receiving a user-inputted food dispensing amount and a user-inputted food dispensing time interval; and
controlling the food dispenser to dispense the user inputted dispensing amount of food over the food dispensing time interval.

21. The method of claim 20, wherein the user-inputted amount of food is dispensed in equal portions of the amount at regularly spaced time points over the user-inputted dispensing time interval.

22. A method for controlling a robotic pet accompaniment system having a displacement subsystem operable to displace the robotic pet accompaniment system, a housing, a food dispenser for selectively dispensing food, and a plurality of distance-enabled spatial sensors, the method comprising:
controlling the displacement subsystem to cause displacement of the robotic pet accompaniment system over an underlying surface by:
receiving sensed data from the plurality of distance-enabled sensors of the spatial sensors, the sensed data indicating presence and distance of obstacles in an environment surrounding the housing; and
determining a direction of displacement based on the received sensed data and wherein the direction of displacement corresponds to a longest unobstructed path; and
wherein the displacement subsystem is controlled to cause displacement in the determined direction of displacement; and
controlling the food dispenser to intermittently dispense food.
